(19) United States
(12) Patent Application Publication
(10) Pub. No.: US 2009/0223742 A1
(43) Pub. Date: Sep. 10, 2009

(54) EXTENDING PORTABLE TREE STAND

(76) Inventor: Dean LePage, Regina (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/192,634

(22) Filed: Aug. 15, 2008

(30) Foreign Application Priority Data
Mar. 4, 2008 (CA) 2624211

(51) Int. Cl. E06C 7/16

(52) U.S. Cl. 182/123; 182/116

(57) ABSTRACT

A portable elevated observation chair is provided. The portable elevated observation chair has a telescopically extendable ladder and a seat attached at a back end of the seat to the extendable ladder with a foot rest attached below the seat. The chair can be carried to a location with the extendable ladder in the retracted position and then used as a observation chair by extending the extendable ladder and positioning a top end of the extendable ladder against a trunk of a tree so that the extendable ladder is leaning against the tree with the seat and footrest extending substantially horizontally from the extendable ladder.

This invention is in the field of portable observation apparatuses and in particular an observation apparatus that can be converted from an upright position into a compact position for transport.

### BACKGROUND OF THE INVENTION

Elevated platforms are useful for hunters, photographers and observers of wildlife who seek to limit the possibility of being noticed by the animals or require a higher vantage point than the ground with which to view the animals. This elevation allows a person to maintain a proximate position relative to the animals while at the same time decreasing the possibility of frightening or scaring off the animals. Additionally, by elevating a person above the ground, the elevated platform can enable a person to see over low vegetation or other obstacles giving the person a better line of sight with an animal.

These elevated platforms must be able to be erected so that they have a platform suitable for at least one person to sit or stand so that the person is several feet above the ground (commonly 8′ or more). These platforms must also be strong enough to support the weight of a person and any equipment that they may have, as well as provide a means for a person to gain access to the elevated platform. Additionally, because these elevated platforms are used to hunt or view wild animals, these elevated platforms are typically placed in relatively remote areas, many of which are also relatively inaccessible.

One type of these elevated platforms is the relatively permanent elevated platforms. These permanent elevated platforms are constructed in a specific location and then left in that location for a significant period of time, such as weeks or even years. The people who construct these permanent elevated platforms often use these platforms numerous times, often over several years. Because they are relatively permanent structures (i.e. they are not meant to be portable and moved from location to location) they can be easily constructed for sufficient strength to hold one or more people and their equipment. Additionally, because they are built in place the ease of erection is not a concern because the builder usually has sufficient time in which to assemble these permanent elevated platforms. The builder is also not concerned with having to erect the permanent elevated platform quietly and quickly so as not to disturb or miss animals in the area because these permanent elevated platforms are meant to be used at a later date from when the platform is constructed and over a relatively long period of time rather than for a short period of time, immediately after construction.

These permanent elevated platforms are limited to only one specific location. Once these permanent elevated platforms are constructed they remain in that location until they are taken down. Not only is a person limited to one specific location with these elevated platforms, but they typically must also either own the land the permanent elevated platform has been constructed on or must have permission to erect the permanent elevated platform in its location. This prevents these permanent elevated platforms to be erected in parks or other locations that a person using the elevated platform only has temporary permission to enter or does not have permission to erect a long term structure.

The other type of elevated platform is the portable elevated platforms. These portable elevated platforms are typically designed so that they can be convertible from a “transport” mode to an “operational” mode. These portable elevated platforms are converted into some type of “transport” mode and then transported to a location a user wishes to use the portable elevated platform. The portable elevated platform is then convened or setup into an “operational” mode for use by the person. Unlike the relatively permanent elevated platforms that are constructed in a single place, these portable elevated platforms are designed so that they can be moved from place to place and relatively quickly setup for use.

Some of these portable elevated platforms, such as those shown in U.S. Pat. No. 5,105,908 to Frenud, U.S. Pat. No. 5,314,042 to Adams, U.S. Pat. No. 5,566,780 to Bambrough, U.S. Pat. No. 5,839,538 to Magyar, U.S. Pat. No. 5,295,555 to Strange and U.S. Pat. No. 5,564,523 to Howard, are quite substantial structures. These portable elevated platforms are designed to be transported by a powered vehicle, limiting their use to areas accessible by powered vehicles and due to the noise and commotion their transport and setup usually entails, prevents them from being moved into an area quickly and setup quietly while wildlife is nearby without disturbing the wildlife.

Many portable elevated platforms are designed to be carried or transported by a single person on foot. This allows the elevated platform to be carried into relatively remote and inaccessible areas and relatively quickly setup by a person to be used. However, these portable elevated platforms must strike a balance between ease of setup, strength and weight. It is desirable to have a quick and easy setup for these portable elevated platforms. It is also necessary that these portable elevated platforms be sufficiently strong to support the weight of a person and his or her equipment. However, balancing out the strength and ease of setup is the weight and easy of portability of the elevated platform, these portable elevated platforms must be able to be placed in a “transport position” where they can be carried or moved by a single person.

Several elevated platforms that can be converted to be transportable are taught in the following references U.S. Pat. No. 5,485,978, Cdn. Pat. No. 1,231,686, Cdn. Pat. No. 2,342,127 and Cdn. Pat. No. 1,122,180.

### SUMMARY OF THE INVENTION

It is an object of the present invention to provide a portable observation apparatus that can be converted into a compact form for transport by a single person yet still provide a reasonably stable platform when in use.

In a first aspect, a portable elevated observation chair is provided. The portable elevated observation chair has an extendable ladder, the extendable ladder being telescopically extendable from a retracted position to an extended position, the extendable ladder having a top end and a bottom end; and a seat attached at a back end of the seat to the extendable ladder below the top end of the ladder, the seat angled away from the extendable ladder so that a user can sit on the seat when the extendable ladder is in the extended position and leaning against an object. The portable elevated observation chair can be carried in the retracted position and then used as a portable elevated observation chair by extending the extendable ladder to the extended position and positioning the top end of the extendable ladder against a trunk of a tree so that the extendable ladder is leaning against the tree with the seat extending substantially horizontally from the extendable ladder.

In a second aspect, a portable elevated observation chair is provided. The portable elevated observation chair has an extendable ladder having a top end and a bottom end, the extendable ladder comprising a bottom ladder section and a plurality of additional ladder sections, the bottom ladder section and each additional ladder section comprising two spaced apart parallel side members and a rung attached to a top end of each side member, the pair of side members being hollow so that each pair of side members of an additional ladder section is telescopically slidable into the pair of side members in a lower adjacent ladder section so that the extendable ladder is telescopically extendable from a retracted position, with each pair of side members of each additional ladder section retracted inside a pair side members of a lower adjacent ladder section, to an extended position, a seat pivotally attached at a back end of the seat to the extendable ladder below the top end of the ladder, such that the seat can be pivoted to angle away from the extendable ladder so that seat extends substantially horizontally when the extendable ladder is in the extended position and leaned against an object and the seat can be pivoted to lie against the extendable ladder when the extendable ladder is in the retracted position and a foot rest pivotally attached at a back end of the foot rest to the extendable ladder below the seat, such that the foot rest can be pivoted to extend at an angle from the extendable ladder and the foot rest can be pivoted to lie against the extendable ladder.

In a third aspect, a method is provided. The method comprises the steps of providing a telescopically extendable ladder having a seat pivotally connected at a back end of the seat to the extendable ladder below a top end of the extendable ladder, extending the extendable ladder, pivoting the seat so that the seat is extends at an angle relative to the extendable ladder and positioning the top end of the extendable ladder against a trunk of a tree, such that a bottom end of the ladder is positioned farther away from the trunk of the tree then the top end, so that the extendable ladder leans against the trunk of the tree.

In an aspect a portable elevated platform is provided. The portable elevated platform has a telescopically extendable ladder that can be extended to full length or collapsed to be made portable. Proximate to a top end of the extendable ladder is a seat that is pivotally connected at a back end of the seat to the extendable ladder and a foot rest pivotally connected at a back end of the footrest to the extendable ladder, below the seat.

The portable elevated platform can be collapsed so that it can be transported by a single person to a location where the person wishes to use the portable elevated platform. When a person has carried the portable elevated platform to the desired location and wants to use the portable elevated platform, he or she can extend the extendable ladder and place a top end of the extendable ladder against a convenient tree. The user can then secure the top end of the extendable ladder to the tree and pivot the seat and footrest so that they are substantially horizontal. Typically, the seat and footrest are held in the substantially horizontal positions by corresponding support members. Once set up in this position, a user can then sit in the seat, where he or she will be elevated above the ground surface.

When the user is finished using the portable elevated platform, he or she can pivot the seat and footrest against the extendable ladder, remove the top end of the extendable ladder from the tree and collapse the extendable ladder. With the portable elevated platform in the collapsed position, the user can then pick up and carry the portable elevated platform.

In a further aspect, straps are provided so that a user can carry the portable elevated platform on his or her back. In a further aspect, a bag mounted to a frame releasably attachable to the collapsed portable elevated platform is provided so that a user can carry both the collapsed portable elevated platform and a bag for additional items on his or her back.

In a further aspect, a brace is provided that can be positioned between a tree the portable elevated platform is placed against and one of the rungs of the extendable ladder to reduce or prevent the extendable ladder from flexing when the portable elevated platform is in place against a tree and a user is climbing the extendable ladder or sitting on the seat.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a front view of a portable elevated platform setup for use in an aspect of the present invention;

FIG. 2 is a side view of the portable elevated platform of FIG. 1 setup for use;

FIG. 3 is a side view of the portable elevated platform of FIG. 1 in a retracted position;

FIG. 4 is a front view of the retracted portable elevated platform of FIG. 3;

FIG. 5 is a perspective view at a portion of the extended ladder with the seat and footrest;

FIG. 6 is a side view of the retracted portable elevated platform with straps attached for carrying;

FIG. 7 is a side view of the retracted portable elevated platform with a bag for carrying additional items attached to the collapsed portable elevated platform; and

FIG. 8 is a top view of a brace in an aspect; and

FIG. 9 is a side view of the brace of FIG. 8 in use with the portable elevated platform of FIG. 1.

### DETAILED DESCRIPTION OF THE PREFERRED EMBODIMENTS

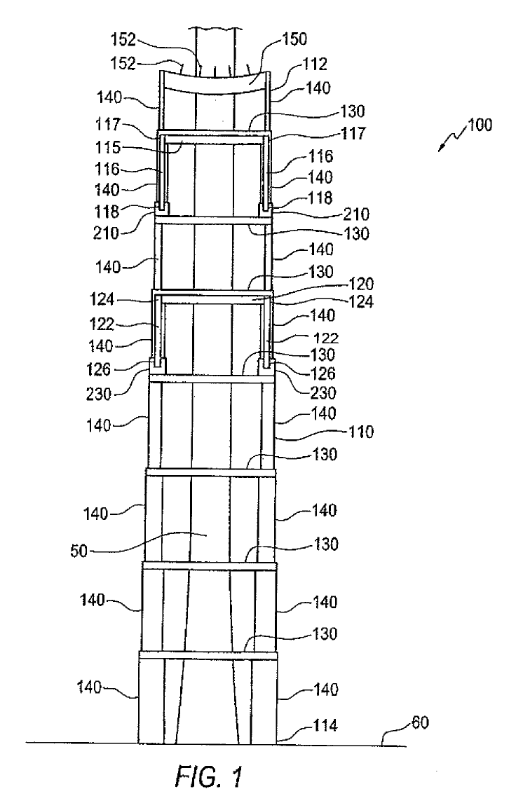

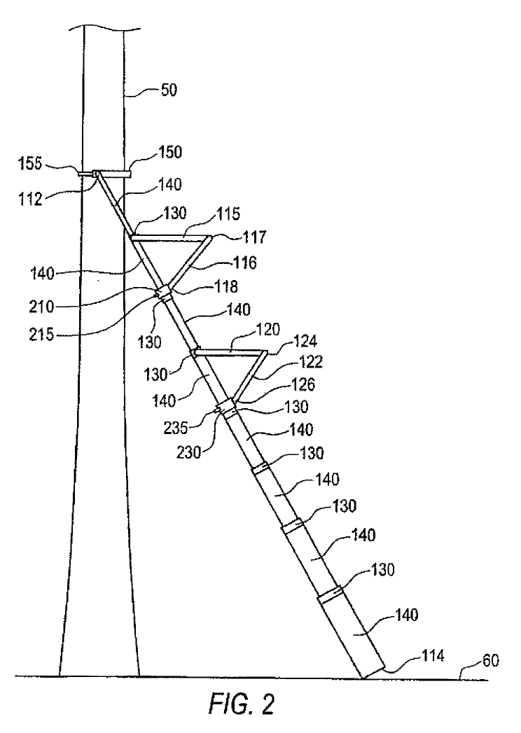

FIGS. 1 and 2 illustrate an aspect of a portable elevated platform 100 setup for use and positioned against a single tree. The extendable ladder 110 is telescopically extendable and has a number of rungs 130 and a number of side members 140 with a seat 115 and a footrest 120.

When the portable elevated platform 100 is setup for use, the extendable ladder 110 is placed in an extended position and the top end 112 of the extendable ladder 110 is positioned against a tree 50. The top end 112 of the portable elevated platform 100 is releasably secured to the tree 50 by a yoke strap 150 and corresponding tensioning strap 155. The yoke strap 150 has a plurality of pins 152 to penetrate into the tree 50 and prevent the yoke strap 150 from sliding up or down the tree 50. The tensioning strap 155 encircles the tree 50 and can be tightened to secure the yoke strap 150 against the tree 50. The bottom end 114 of the extendable ladder 110 is positioned against a ground surface 60 away from the tree 50 so that the length of the extendable ladder 110 is angled towards the tree 50 rather than running vertically, such that each next adjacent higher rung 130 is positioned closer to the tree 50 as a person climbs up the rungs 130 of the extendable ladder 110.

The seat 115 is positioned proximate to the top end 112 of the extendable ladder 110 when the extendable ladder 110 is extended. The seat 115 extends out from the extendable ladder 110 and is supported in a substantially horizontal position by seat members 116 when the portable elevated platform 100 is placed in an extended position for use and positioned against the tree 50. The seat 115 can be made out of metal sheeting, wood, etc. providing a rigid platform for a user to sit on or it can be formed of a fabric sheet to provide some flexibility in the seat 115.

The footrest 120 is also positioned proximate to the top end 112 of the extendable ladder 110 when the extendable ladder 110 is extended and below the seat 115 so that a user sitting on the seat 115 can rest his or her feet on the footrest 120. The footrest 120 extends out from the extendable ladder 110 and is supported in a substantially horizontal position by footrest members 122.

In operation, when the portable elevated platform 100 is setup for use, with the extendable ladder 110 in the extended position, a user places the top end 112 of the extendable ladder 110 against a convenient tree 50. The yoke strap 150 can be placed around the trunk of the tree 50, with the pins 152 (if pins 152 are provided) protruding into the bark or the trunk of the tree 50. The user can then climb the extendable ladder 110 and use the tensioning strap 155 to secure the yoke strap 150 and the top end 112 of the extendable ladder 110 securely to the tree 50. Once the portable elevated platform 100 is securely attached to the tree 50, a user can sit on the seat 115, place his or her feet on the footrest 120 and view the surroundings.

Because of the angling of the extendable ladder 110 relative to the tree 50 and the top end 112 of the extendable ladder 110 being positioned against the tree 50 when the portable elevated platform 100 is setup for use, any weight that is placed on the extendable ladder 110 forces the top end 112 of the extendable ladder 110 and the yoke strap 150 against the tree 50. In this manner, when the portable elevated platform 100 is in use and a user is sitting on the seal 115 of the portable elevated platform 100, some of the weight of the user creates a horizontal force pressing the top end 112 of the extendable ladder 110 and the yoke strap 150 against the tree 50.

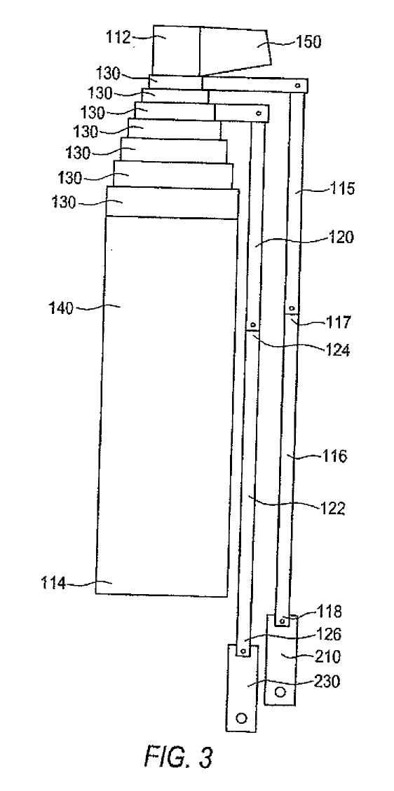

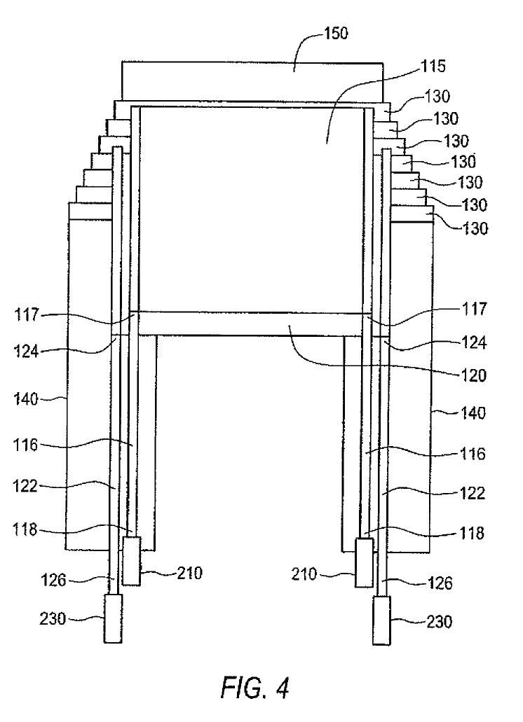

FIGS. 3 and 4 illustrate the portable elevated platform 100 collapsed for transport. Referring again to FIGS. 1-4, a number of ladder sections are provided with each ladder section having a pair of spaced-apart parallel side members 140 that are hollow and slightly larger than the pair of side members 140 in the next higher adjacent ladder section in the extendable ladder 110. In this manner, each pair of side members 140 in a ladder section can be retracted into the pair of side members 140 in a lower adjacent ladder section which have a slightly larger cross-section. The nearer a pair of side members 140 to the top end 112 of the extendable ladder 110, the smaller the cross-sections of the pair of side member 140 is, with the pair of side members 140 in a top ladder section at the top end 112 of the extendable ladder 110 having the smallest cross-section and in one aspect lacking a rung 130 at the top of these side members 140.

When a pair of side members 140 of a ladder section are retracted into the pair of side members 140 in an adjacent lower ladder section the rung 130 connecting the pair side members 140 is positioned adjacent to the rung 130 connecting the lower pair of side members 130. When the extendable ladder 110 is completely collapsed, the rungs 130 are stacked one on top of the other (as shown in FIGS. 3 and 4).

Referring again to FIGS. 3 and 4, in the collapsed position, the portable elevated platform 100 is not much higher than the length of the pair of side members 140 in a bottom ladder section at the bottom end 114 of the extendable ladder 110 plus the height of all the rungs 130 lying adjacent to each other.

Referring again to FIGS. 1 and 2, when a user wishes to use the portable elevated platform 100, a user can telescopically extend the extendable ladder 110 by sliding each pair of side members 140 out of their adjacent lower pair of side members 140 until the extendable ladder 110 is extended to the desired length. Typically, a locking mechanism is provided for each pair of side members 140 allowing the pair of side members 140 to be locked in place and to prevent them from sliding back into the adjacent lower pair of side members 140.

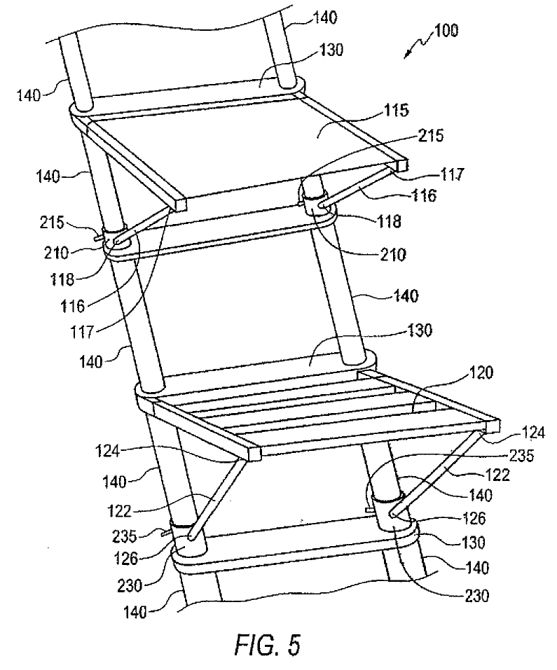

FIGS. 5 illustrates a sectional view of the extendable ladder 110 showing the seat 115 and the footrest 120. To place the portable elevated platform 100 in a more compact position so that the portable elevated platform 100 can be moved or transported, the seat 115 and footrest 120 can be pivoted to lie adjacent to the extendable ladder 110.

The rear of the seat 115 is pivotally connected to the extendable ladder 110 and the seat supports 116 are pivotally connected at a top end 117 to the front of the seat 115. The bottom ends 118 of the seat support members 116 are pivotally connected to collars 210 that are sized to partially encircle the seat support members 116 and a pin 215 or other device is used to secure the collars 210 around the side members 140 when the portable elevated platform 100 is setup for use. The rung 130 below the collars 210 prevent the collars 210 from sliding lower than the rung 130.

To collapse the portable elevated platform 100 for transport, the pin 215 can be removed from the collars 210 allowing the collars 210 to be slipped off of the side members 140. The seat 115, pivotally attached to the extendable ladder 110, and the seat member supports 116, pivotally attached to the seat 115, can then be pivoted so that the seat 115 and seat member supports 116 lie against the extendable ladder 110.

In the same manner as the seat 115, the footrest 120 can be positioned so that the portable elevated platform 100 can be collapsed for transport. The footrest 120, like the seat 115, is also pivotally connected to the extendable ladder 110 at the rear of the footrest 120 with the footrest support members 122 pivotally connected to the front of the footrest 120 at top ends 124 of the footrest support members 122. Bottom ends 126 of the footrest support members 122 are pivotally connected to collars 230 that at least partially encircle the side members 140 with a pin 235 to secure the collars 230 around the side members 140.

To collapse the portable elevated platform 100 and place it in the retracted position for transport, the pins 235 are removed from the back of the collars 230 so that the bottom ends 126 of the footrest support members 122 can be removed from around the side members 140. The footrest 120 and footrest support members 122 can then be pivoted to lie against the extendable ladder 110.

In this manner, to prepare the portable elevated platform 100 for transport, the bottom ends 118 of the seat support members 116 and the bottom ends 126 of the footrest support members 122 can be disconnected from the side members 140 and the seat 115 and footrest 120 pivoted to lie against the extendable ladder 110. The extendable ladder 110 can then be placed in the retracted position by sliding each pair of side members 140 inside the pair of side members 140 positioned beneath them until all of the side support members 140 are retracted into the bottom pair of side members 140 in the bottom ladder section. This results in the depth of the portable elevated platform 100 being not much deeper than the depth of the bottom pair of side members 140 and the height of the portable elevated platform 100 being not much higher than the height of the top pair of side members 140 in the top ladder section (the height being limited to the distance a person could reasonably be expected to climb or step from one rung 130 to the next rung 130 in the extendable ladder 110).

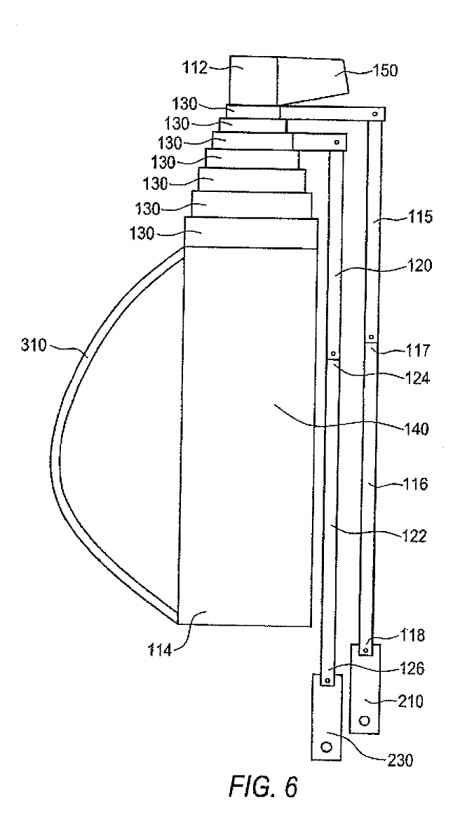

FIG. 6 illustrates a further aspect of the portable elevated platform 100 where straps 310 are used to aid in transporting the portable elevated platform 100. A pair of straps 310 are connected either permanently or removably near the top end of the side members 140 in the bottom ladder section and near the bottom end of the side members 140 in the bottom ladder section.

In this manner, when the portable elevated platform 100 is placed in the retracted position for transport, a person can use the pair of straps 310 to carry the collapsed portable elevated platform 100 on his or her back.

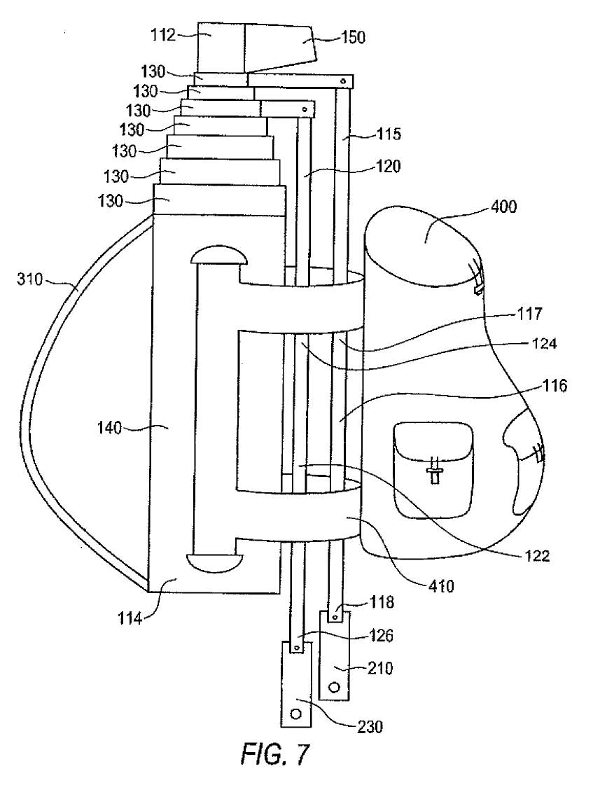

FIG. 7 illustrates a farther aspect, where a bag 400 for carrying additional equipment or other items is connected to the portable elevated platform 100. In an aspect, the bag 400 is attached to a rigid frame 410. The rigid frame 410 is then removably connectable to the collapsed portable elevated platform 100 on the other side of the portable elevated platform 100 from the pair of straps 310.

In this manner, a user can collapse the portable elevated platform 100 for transport, connect the bag 400 and rigid frame 410 to the collapsed portable elevated platform 100 and carry the portable elevated platform 100 and attached bag 400 on his or her back using the straps 310. The user can then transport the portable elevated platform 100 by carrying the portable elevated platform 100 to a location they wish to set the portable elevated platform 100 up in, using the straps 310 and carrying any additional items in the bag 400.

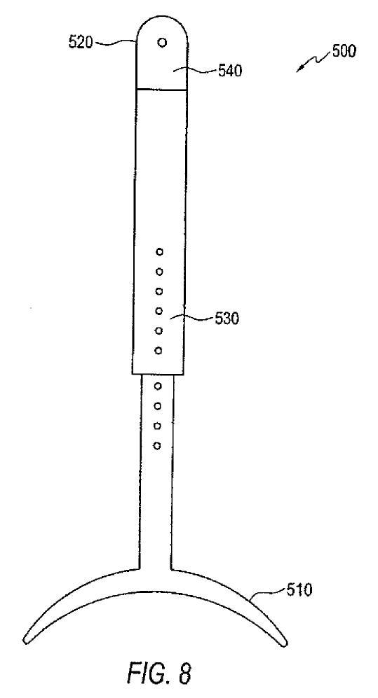

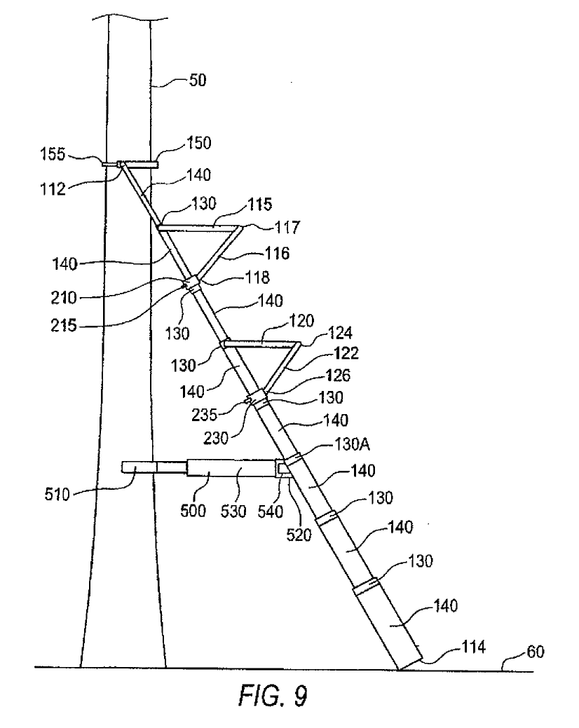

FIG. 8 illustrates a brace 500 and FIG. 9 illustrates the brace 500 in place on the portable elevated platform 100. The brace 500 is for use in bracing the middle of the extendable ladder 110 when the portable elevated platform 100 is in use. This brace 500 is useful when the extendable ladder 110 is relatively long to prevent the extendable ladder 110 from flexing when a user is climbing the extendable ladder 110 or sitting on the seat 115.

The brace 500 is selectively extendable and has a first end 510 having a curved member to be positioned against the trunk of the tree 50. A shaft 530 of the brace 500 is selectively extendable so that the shaft 530 can be sized to fit between a suitable rung 130 of the extendable ladder 110 and the tree 50.

The first end 510 of the brace 500 can be secured against the tree 50 with a tensioning strap (not shown) to secure it in place against the tree 50. The other end 520 of the brace 500 can then be secured to the rung 130A of the extendable ladder 110 such as by providing flanges 540 that pass over and under the rung 130A. The extension of the brace 500 between the tree 50 and the rung 130A can keep the flanges 540 in position around the rung 130A or optionally a pin or other device (not shown) can be used to secure the flanges 540 around the rung 130.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A portable elevated observation chair comprising:
an extendable ladder, the extendable ladder being telescopically extendable from a retracted position to an extended position, the extendable ladder having a top end and a bottom end; and
a seat attached at a back end of the seat to the extendable ladder below the top end of the ladder, the seat angled away from the extendable ladder so that a user can sit on the seat when the extendable ladder is in the extended position and leaning against an object,
whereby the portable elevated observation chair can be carried in the retracted position and then used as a portable elevated observation chair by extending the extendable ladder to the extended position and positioning the top end of the extendable ladder against a trunk of a tree so that the extendable ladder is leaning against the tree with the seat extending substantially horizontally from the extendable ladder.

2. The portable elevated observation chair of claim 1 wherein the extendable ladder comprises a bottom ladder section and a plurality of additional ladder sections, the bottom ladder section and each additional ladder section comprising two spaced apart parallel side members and a rung attached to a top end of each side member, the pair of side members being hollow so that each pair of side members of an additional ladder section is telescopically slidable into the pair of side members in a lower adjacent ladder section.

3. The portable elevated observation chair of claim 2 wherein the seat is pivotally attached at a back end of the seat to the extendable ladder, the seat pivotally attached at a rear end of the seat to the extendable ladder such that the seat can be pivoted to extend substantially horizontally from the extendable ladder when the extendable ladder is in the extended position and leaned against an object and the seat can be pivoted to lie against the extendable ladder when the extendable ladder is in the retracted position.

4. The portable elevated observation chair of claim 3 wherein a top ladder section is provided at the top end of the extendable ladder, the top ladder section having two spaced-apart substantially parallel side members operative to slide inside a pair of side members of a lower adjacent additional ladder section, and the seat is pivotally connected to a rung in an additional ladder section lower than the top ladder section.

5. The portable elevated observation chair of claim 4 wherein a yoke strap is provided between the side members of the top ladder section.

6. The portable elevated observation chair of claim 5 wherein the yoke strap has pins to secure the yoke strap against a trunk of a tree.

7. The portable elevated observation chair of claim 5 further comprising a tensioning strap, the tensioning strap working in conjunction with the yoke strap to secure the top end of the extendable ladder against a trunk of a tree.

8. The portable elevated observation chair of claim 3 further comprising a foot rest, the foot rest pivotally attached at a back end of the foot rest to the extendable ladder below the seat such that the foot rest can be pivoted to extend at an angle from the extendable ladder when the extendable ladder is in the extended position and the foot rest can be pivoted to lie against the extendable ladder when the extendable ladder is in the retracted position.

9. The portable elevated observation chair of claim 2 further comprising at least one shoulder strap attachable to the extendable ladder whereby a user can carry the portable elevated observation chair on a back of the user when the extendable ladder is in the retracted position.

10. The portable elevated observation chair of claim 9 wherein the at least one shoulder strap is attachable to a first side of the extendable ladder, the first side of the extendable ladder opposite a second side of the extendable ladder and further comprising a bag attachable to the second side of the extendable ladder, whereby a user can carry items in the bag.

11. The portable elevated observation chair of claim 2 further comprising an elongate brace having a first end and a second end, the first end having a member for placement against a trunk of a tree and the second end having a flange sized to fit a rung of the extendable ladder.

12. The portable elevated observation chair of claim 11 wherein the brace is selectively extendable.

13. A portable elevated observation chair comprising:
an extendable ladder having a top end and a bottom end, the extendable ladder comprising a bottom ladder section and a plurality of additional ladder sections, the bottom ladder section and each additional ladder section comprising two spaced apart parallel side members and a rung attached to a top end of each side member, the pair of side members being hollow so that each pair of side members of an additional ladder section is telescopically slidable into the pair of side members in a lower adjacent ladder section so that the extendable ladder is telescopically extendable from a retracted position, with each pair of side members of each additional ladder section retracted inside a pair side members of a lower adjacent ladder section, to an extended position;
a seat pivotally attached at a back end of the seat to the extendable ladder below the top end of the ladder, such that the seat can be pivoted to angle away from the extendable ladder so that seat extends substantially horizontally when the extendable ladder is in the extended position and leaned against an object and the seat can be pivoted to lie against the extendable ladder when the extendable ladder is in the retracted position; and
a foot rest pivotally attached at a back end of the foot rest to the extendable ladder below the seat, such that the foot rest can be pivoted to extend at an angle from the extendable ladder and the foot rest can be pivoted to lie against the extendable ladder.

14. A method comprising:
providing a telescopically extendable ladder having a seat pivotally connected at a back end of the seat to the extendable ladder below a top end of the extendable ladder;
extending the extendable ladder;
pivoting the seat so that the seat is extends at an angle relative to the extendable ladder; positioning the top end of the extendable ladder against a trunk of a tree, such that a bottom end of the ladder is positioned farther away from the trunk of the tree then the top end, so that the extendable ladder leans against the trunk of the tree.

15. The method of claim 14 further comprising securing the top end of the extendable ladder to the trunk of the tree.

16. The method of claim 15 wherein the top end of the extendable ladder is secured to the trunk of the tree by a tensioning strap.

17. The method of claim 14 further providing a foot rest pivotally attached at a back end of the foot rest to the extendable ladder below the seat and the method further comprising the step of pivoting the footrest to extend at an angle from the extendable ladder.
